(19) United States
(12) Patent Application Publication
(10) Pub. No.: US 2018/0230364 A1
(43) Pub. Date: Aug. 16, 2018

(54) PROPPANT COMPOSITION AND METHOD

(71) Applicant: Haliburton Engergy Services, Inc., Houston, TX (US)

(72) Inventors: Jim Weaver, Duncan, OK (US); Michael A. McCabe, Duncan, OK (US); Ronnie G. Morgan, Waurik, OK (US)

(21) Appl. No.: 15/516,627

(22) PCT Filed: Dec. 11, 2014
(86) PCT No.: PCT/US2014/069742

§ 371 Date: Apr. 3, 2017

(51) Int. Cl. C09K 8/80; E21B 43/267

(52) U.S. Cl. CPC C09K 8/805; E21B 43/267

(57) ABSTRACT

This present application relates generally to fracture-treatment compositions and methods that provide for a proppant having a first angle of repose, a chemical additive coated on the proppant, wherein the coated proppant has a second angle of repose and the second angle of repose is no more than 10% greater than the first angle of repose.

### FIELD OF INVENTION

This present application relates generally to fracture-treatment, and more specifically, to controlling and handling dust from proppants used in fracture-treatment.

### BACKGROUND

Hydraulic fracturing is a stimulation treatment routinely performed on oil and/or gas wells. “Fracturing” refers to the method of pumping a fluid into a well until the pressure increases to a sufficient level to fracture the subterranean geological formations. A propping agent or “proppant” is injected, along with a hydraulic fluid, into the wellbore to maintain open the newly formed fractures extending from the wellbore in generally opposing directions. The proppant remains in place once the hydraulic pressure is removed and therefore props open the fracture to enhance flow in the wellbore.

Proppants can be made of virtually any generally solid particle that has sufficient particle strength, sphericity and size. Silica-containing material, like sand, and ceramic materials have proved to be especially suitable for use in hydraulic fracturing.

When preparing proppant for use in hydraulic fracturing, large amounts of dust, such as silica dust and other proppant dust, is created during the movement and transfer of proppants. This dust can produce potential detrimental effects, such as contaminating atmospheric air, creating a nuisance to adjacent landowners, and damaging equipment on the hydraulic fracturing site. In addition, the Occupational Safety and Health Administration proposed a new permissible exposure limit for respirable crystalline silica (quartz, cristobalite and tridymite) of 50 μg/m³ in all industry sectors.

### BRIEF DESCRIPTION OF THE FIGURES

FIG. 1 is a diagram illustrating an example of a fracturing system that may be used in accordance with certain embodiments of the present disclosure.

FIG. 2 is a diagram illustrating an example of a subterranean formation in which a fracturing operation may be performed in accordance with certain embodiments of the present disclosure.

FIG. 3 is a diagram illustrating an example of a fracturing system that may be used in accordance with certain embodiments of the present disclosure.

FIG. 4 is a diagram illustrating an example of a pneumatic line that may be used in accordance with certain embodiments of the present disclosure.

FIG. 5 is a diagram illustrating an example of a pneumatic line that may be used in accordance with certain embodiments of the present disclosure.

FIG. 6 is a diagram illustrating an example of angles of repose that may be used in accordance with certain embodiments of the present disclosure.

FIG. 7 is a diagram illustrating and example of a fluidized bed coating system that may be used in accordance with certain embodiments of the present disclosure.

FIG. 8 is a diagram illustrating and example of a fluidized bed coating apparatus to ensure uniform coating of proppant that may be used in accordance with certain embodiments of the present disclosure.

FIG. 9 is an example illustrating the effect of surfactant concentration on 20/40 mesh sand.

### DETAILED DESCRIPTION

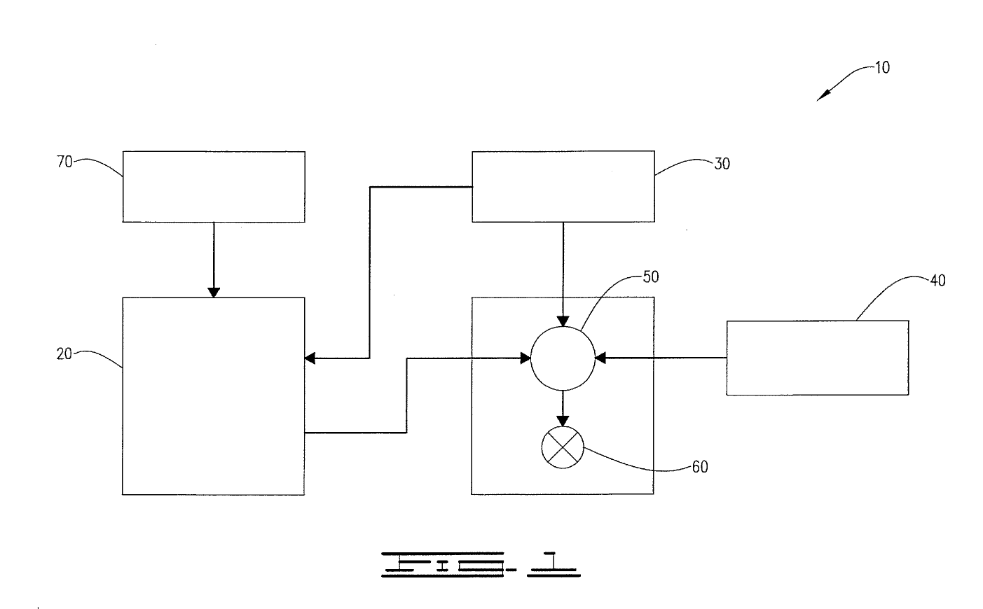

The exemplary methods and compositions disclosed herein may directly or indirectly affect one or more components or pieces of equipment associated with the preparation, delivery, recapture, recycling, reuse, and/or disposal of the disclosed compositions. For example, and with reference to FIG. 1, the disclosed methods and compositions may directly or indirectly affect one or more components or pieces of equipment associated with an exemplary fracturing system 10, according to one or more embodiments. In certain instances, the system 10 includes a fracturing fluid producing apparatus 20, a fluid source 30, a proppant source 40, and a pump and blender system 50 and resides at the surface at a well site where a well 60 is located. In certain instances, the fracturing fluid producing apparatus 20 combines a gel pre-cursor with fluid (e.g., liquid or substantially liquid) from fluid source 30, to produce a hydrated fracturing fluid that is used to fracture the formation. The hydrated fracturing fluid can be a fluid for ready use in a fracture stimulation treatment of the well 60 or a concentrate to which additional fluid is added prior to use in a fracture stimulation of the well 60. In other instances, the fracturing fluid producing apparatus 20 can be omitted and the fracturing fluid sourced directly from the fluid source 30. In certain instances, the fracturing fluid may comprise water, a hydrocarbon fluid, a polymer gel, foam, air, wet gases and/or other fluids.

The proppant source 40 can include a proppant for combination with the fracturing fluid. The system may also include additive source 70 that provides one or more additives (e.g., gelling agents, weighting agents, and/or other optional additives) to alter the properties of the fracturing fluid. For example, the other additives 70 can be included to reduce pumping friction, to reduce or eliminate the fluid's reaction to the geological formation in which the well is formed, to operate as surfactants, and/or to serve other functions.

The pump and blender system 50 receives the fracturing fluid and combines it with other components, including proppant from the proppant source 40 and/or additional fluid from the additives 70. The resulting mixture may be pumped down the well 60 under a pressure sufficient to create or enhance one or more fractures in a subterranean zone, for example, to stimulate production of fluids from the zone. Notably, in certain instances, the fracturing fluid producing apparatus 20, fluid source 30, and/or proppant source 40 may be equipped with one or more metering devices (not shown) to control the flow of fluids, proppants, and/or other compositions to the pumping and blender system 50. Such metering devices may permit the pumping and blender system 50 can source from one, some or all of the different sources at a given time, and may facilitate the preparation of fracturing fluids in accordance with the present disclosure using continuous mixing or “on-the-fly” methods. Thus, for example, the pumping and blender system 50 can provide just fracturing fluid into the well at some times and at other times combinations of fracturing fluid and proppant.

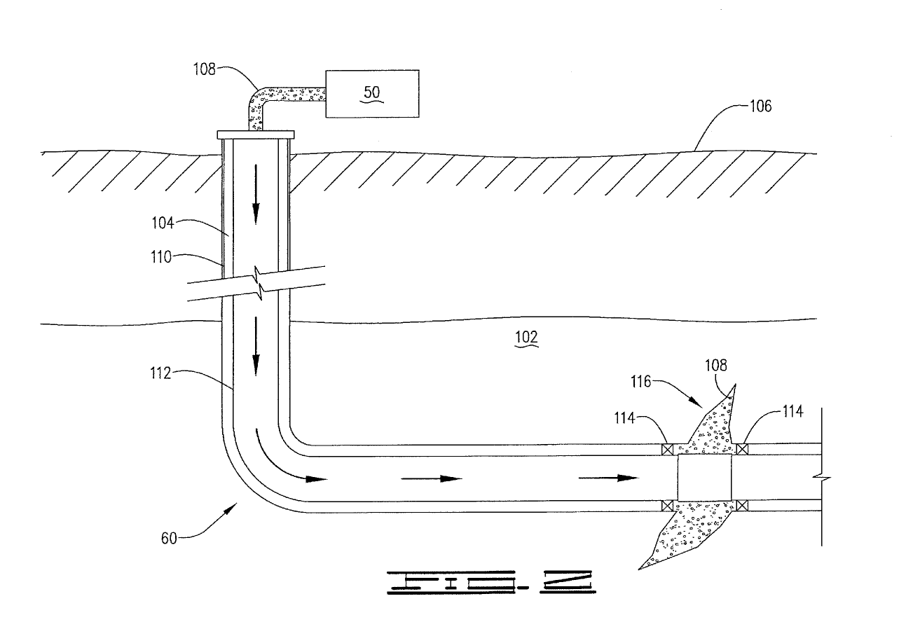

FIG. 2 shows the well 60 during a fracturing operation in a portion of a subterranean formation of interest 102 surrounding a well bore 104. The well bore 104 extends from the surface 106, and the fracturing fluid 108 is applied to a portion of the subterranean formation 102 surrounding the horizontal portion of the well bore. Although shown as vertical deviating to horizontal, the well bore 104 may include horizontal, vertical, slant, curved, and other types of well bore geometries and orientations, and the fracturing treatment may be applied to a subterranean zone surrounding any portion of the well bore. The well bore 104 can include a casing 110 that is cemented or otherwise secured to the well bore wall. The well bore 104 can be uncased or include uncased sections. Perforations can be formed in the casing 110 to allow fracturing fluids and/or other materials to flow into the subterranean formation 102. In cased wells, perforations can be formed using shape charges, a perforating gun, hydro-jetting and/or other tools.

The well is shown with a work string 112 descending from the surface 106 into the well bore 104. The pump and blender system 50 is coupled a work string 112 to pump the fracturing fluid 108 into the well bore 104. The working string 112 may include coiled tubing, jointed pipe, and/or other structures that allow fluid to flow into the well bore 104. The working string 112 can include flow control devices, bypass valves, ports, and or other tools or well devices that control a flow of fluid from the interior of the working string 112 into the subterranean zone 102. For example, the working string 112 may include ports adjacent the well bore wall to communicate the fracturing fluid 108 directly into the subterranean formation 102, and/or the working string 112 may include ports that are spaced apart from the well bore wall to communicate the fracturing fluid 108 into an annulus in the well bore between the working string 112 and the well bore wall.

The working string 112 and/or the well bore 104 may include one or more sets of packers 114 that seal the annulus between the working string 112 and well bore 104 to define an interval of the well bore 104 into which the fracturing fluid 108 will be pumped. For example purposes only, FIG. 2 shows two packers 114, one defining an up-hole boundary of the interval and one defining the down-hole end of the interval. It should be understood that other embodiments may use a greater or lesser number of packers. When the fracturing fluid 108 is introduced into well bore 104 (e.g., in FIG. 2, the area of the well bore 104 between packers 114) at a sufficient hydraulic pressure, one or more fractures 116 may be created in the subterranean zone 102. The proppant particulates in the fracturing fluid 108 may enter the fractures 116 where they may remain after the fracturing fluid flows out of the well bore. These proppant particulates may “prop” fractures 116 such that fluids may flow more freely through the fractures 116.

The disclosed methods and compositions may also directly or indirectly affect any transport equipment used to convey the compositions to the fracturing system 10 such as, for example, any transport vessels, conduits, pipelines, trucks, tubulars, and/or pipes used to fluidically move the compositions from one location to another, any pumps, compressors, or motors used to drive the compositions into motion, any valves or related joints used to regulate the pressure or flow rate of the compositions, and any sensors (i.e., pressure and temperature), gauges, and/or combinations thereof, and the like.

The compounds and methods of this disclosure relate to chemical additives that suppress dust from proppants without adversely affecting the flowability of proppants. As used herein, proppants can be made of virtually any generally solid particle that has sufficient particle strength, sphericity and size. Examples of proppants include silica-containing material, like sand, and ceramic materials have proved to be especially suitable for use in hydraulic fracturing. As used herein, chemical additives are compounds that serve as dust suppressants; that is, compounds that can be used to coat the proppant to reduce the amount of dust that becomes airborne. Particularly preferred are micro particulate tackifying agents; that is, compounds that can be formulated as to have an adhesive, tacky or sticky surface to coat the proppant to reduce the amount of dust that becomes airborne by adhering at least a portion of the proppant dust to the larger proppant particles. In other words, the chemical additives are compounds that collect the dust before it becomes airborne. Generally, chemical additives used as dust suppressants, and in particular micro particulate tackifying agents used on a proppant, result in a less flowable proppant material. It has been discovered that the addition of certain of these chemical additives, in small amounts surprisingly result in an increase in flowability of the proppant material to which they are added. Some of these chemical additives that result in an increase of flowability are surfactants.

Turning now to FIGS. 3-5, the application of a chemical additive to a proppant will now be described. FIG. 3 shows the transfer of the proppant 42 from a first vessel 160 to a second vessel 162 through a pneumatic line 122. First vessel 160 can be a storage vessel or silo, or can be transport equipment 120. The second vessel 162 is typically a storage vessel or silo, or can be pump and blender system 50 (see FIG. 1) in which the proppant is mixed with a fracturing fluid 108 prior to being pumped down the well 60 during well treatment operations. Proppant 42 flows through the pneumatic line 122 pushed by airflow. During the transit of proppant 42 through pneumatic line 122 a chemical additive 72 is applied to the proppant 42 to produce a coated proppant 44. Thus, second vessel 162 receives a coated proppant 44.

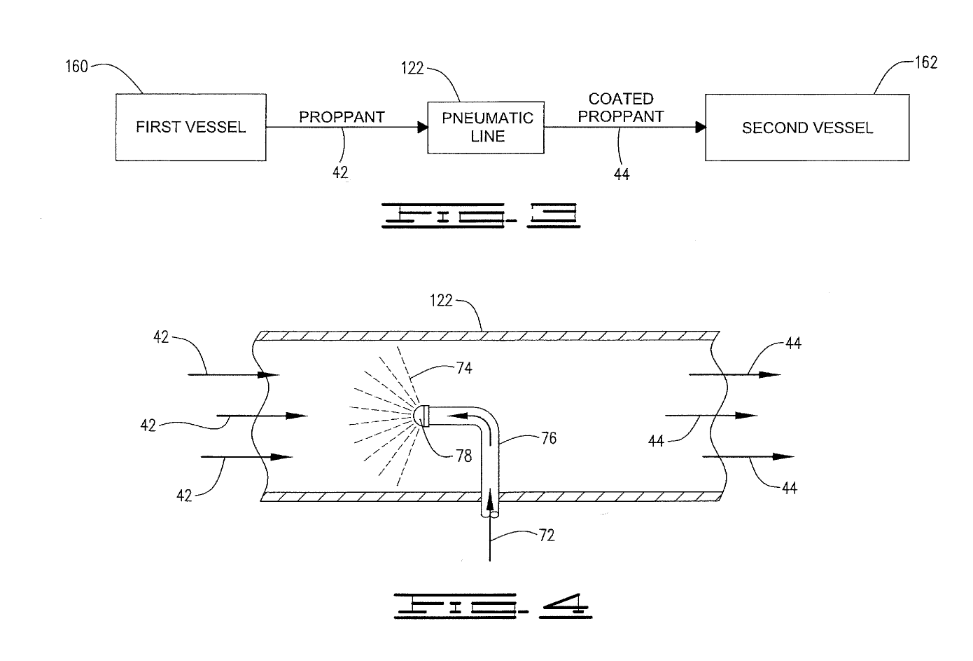

FIG. 4 shows one method of applying the chemical additive to the proppant. The application of the chemical additive 72 occurs by injecting the chemical additive 72 into the pneumatic line 122 such that a mist of atomized droplets 74 of the chemical additive 72 are applied to the proppant 42 by countercurrent contact. The atomized droplets 74 of the chemical additive 72 can have a mean particle size of about 100 microns or less in size. Often the mean particle size can be 75 microns or less and can be 50 microns or less or 20 microns or less.

As illustrated in FIG. 4, a high-pressure sprayer 76 is positioned within pneumatic line 122 with a atomizer nozzle 78 directed counter to the flow of proppant within pneumatic line 122. Chemical additive 72 is pumped into high-pressure sprayer 76 and then exits the atomizer nozzle 78 as a fine mist.

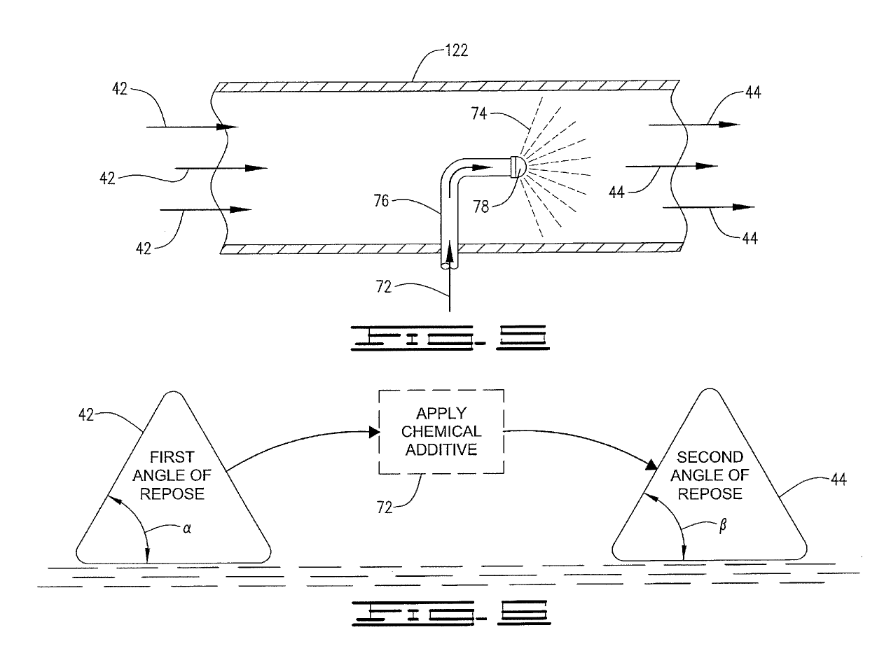

FIG. 5 shows another embodiment, where the high-pressure sprayer 76 is positioned within in pneumatic line 122 such that atomizer nozzle 78 is directed inline with the flow of proppant 42 within pneumatic line 122. Thus, application of the chemical additive 72 occurs by injecting the chemical additive 72 into the pneumatic line 122 such that a mist of atomized droplets 74 of the chemical additive 72 are applied to the proppant 42 by introducing the mist 74 in-line with the flow of proppant 42.

Turning now to FIG. 6, proppant 42 has a first angle of repose α. In general, an angle of repose is the maximum angle to the horizontal at which a material, such as a proppant 42, will remain without sliding. ASTM C 1444-00 is the standard test method for measuring the angle of repose of free-flowing mold powders. The angle of repose indicates how well a material made up of discreet particles, such as proppant, will flow. Higher angles of repose indicate less flowable material and lower angles of repose indicate more flowable materials. It has been discovered that a small amount of chemical additive added to a proppant does not decrease the flowability of the proppant and can increase the flowability of the proppant, even when a tackifying agent is used, whereas large amounts will have an adverse effect on the proppant's ability to flow, that is, it will decrease the proppant's flowability. Accordingly, chemical additive 72 can be added to proppant 42 wherein the chemical additive is added in amount such that the resulting coated proppant 44 has a second angle of repose β that is not more than 10% greater than the first angle of repose α. In some embodiments, the chemical additive is added in an amount such that the second angle of repose β is not more than 5% greater than the first angle of repose α. In other embodiments, the chemical additive is added in such an amount that the second angle of repose β is equal to or less than the first angle of repose α. In still other embodiments, the second angle of repose β is less than the first angle of repose α, and can be less than the first angle of repose α by at least 0.25 degrees, at least 0.5 degrees or at least 1 degree. In addition, a chemical additive can be added in an amount such that the second angle of repose β is less than the first angle of repose α by from about 0.25 degrees to about 5 degrees and more typically from 0.5 degrees to 5 degrees or from 0.5 degrees to 4 degrees.

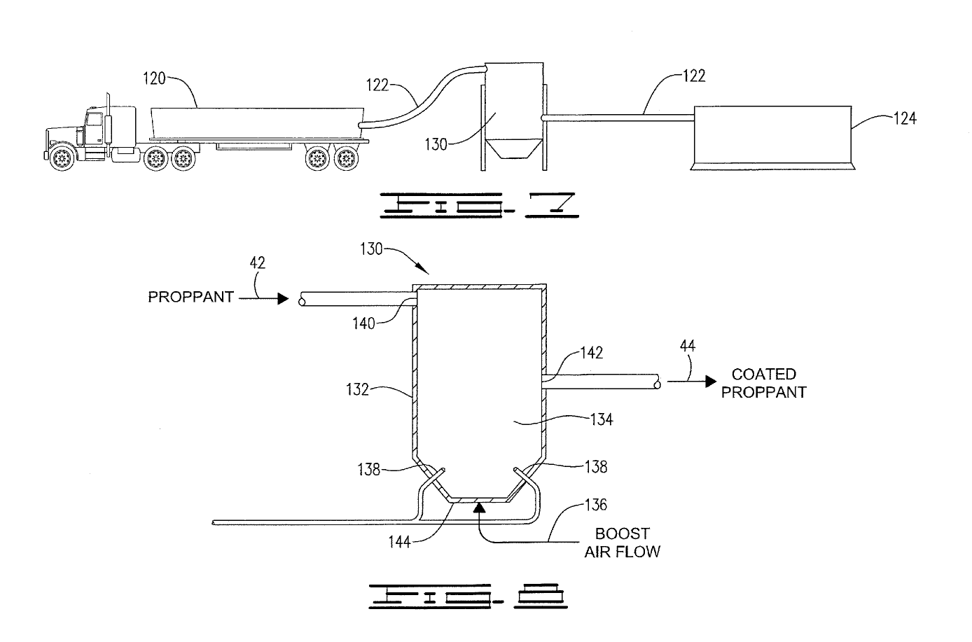

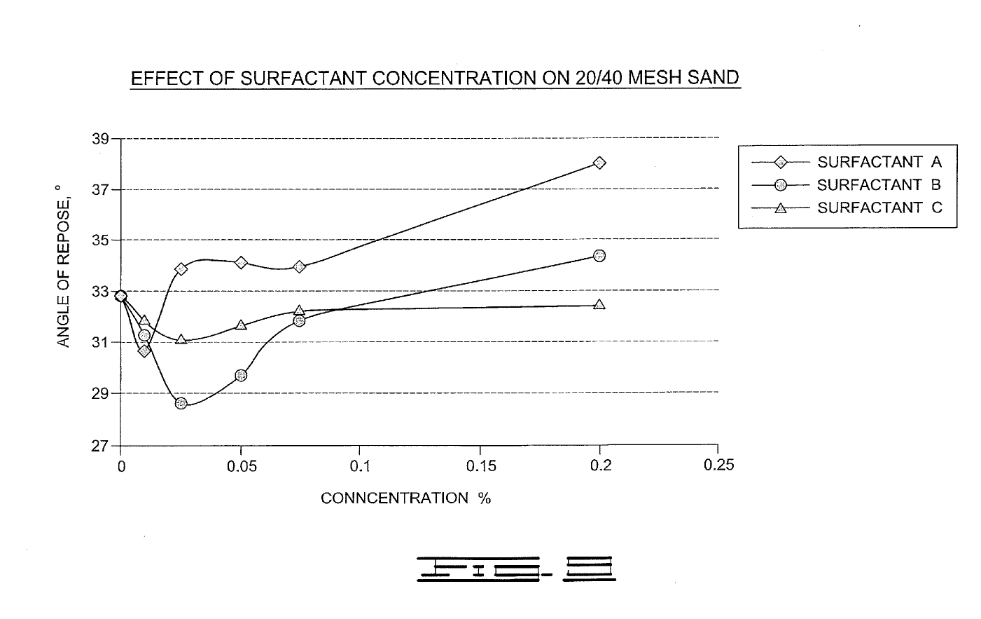

FIGS. 7-8 show another embodiment of the disclosure, where a simplified representation of a fluidized bed coater 130 is interspersed within the pneumatic line 122 so that application of the chemical additive 72 to the proppant 42 is by the fluidized bed coater 130. In FIG. 7, the first vessel is illustrated as a truck trailer 120 and the second vessel as a proppant storage tank 124.

In FIG. 8, the simplified representation of the fluidized bed coater 130 comprises a housing 132 defining a coating chamber 134 for receiving proppant 42 to be coated. The fluidized bed coater 130 has a flow line 136 for delivering air into an underside 144 of the coating chamber 134. The flow line 136 is operable for directing the airflow such that the proppant 42 is circulated. As air circulates the proppant 42, opposing spray nozzles 138 projecting upwardly from an underside 144 of the coating chamber 134, spray the chemical additive 72 into the coating chamber 134. The fluidized bed coater 130 has a proppant inlet 140 to receive proppant and a coated proppant outlet 142 to release coated proppant 44. The fluidized bed coater 130 can also have a system of internal partitions or baffles (not shown) to aid in even chemical distribution and controlled proppant flow.

Often a coated proppant with a concentration of chemical additive equal to or less than 0.6 weight % based on the total coated proppant additive has a second angle of repose β no more than 10% greater than the first angle of repose α. In another example, the coated proppant may have a concentration of chemical additive equal to or less than 0.5 weight % based on the total coated proppant additive and have a second angle of repose no more than 10% greater than the first angle of repose. In another example, the coated proppant may have a concentration of chemical additive equal to or less than 0.4 weight % based on the total coated proppant additive and have a second angle of repose no more than 10% greater than the first angle of repose. In another example, the coated proppant may have a concentration of chemical additive equal to or less than 0.2 weight % based on the total coated proppant additive and have a second angle of repose no more than 10% greater than the first angle of repose. In still another example, the coated proppant may have a concentration of chemical additive equal to or less than 0.15 weight % based on the total coated proppant additive and have a second angle of repose no more than 10% greater than the first angle of repose. Typically, the coated proppant will have a concentration of chemical additive of at least 0.001 weight % based on the total coated proppant additive and can have a concentration of chemical additive of at least 0.002 weight % or at least 0.005 weight %.

Generally, the chemical additive is a dust suppressant and, more preferably, can be a micro particulate tackifying agent. Typically, the chemical additive comprises and may consist essentially of a surfactant, such as ethylene oxide/propylene oxide (EO/PO) copolymers based surfactants.

For example, the proppant may be 20/40 mesh sand having a first angle of repose of about 33 degrees. Once coated with a surfactant to a concentration of less than 0.2 weight percent, the second angle of repose might not be more than 10% greater than 33 degrees. In another example, the second angle of repose may be no more than 5% greater than the first angle of repose. In another example, the second angle of repose may be less than the first angle of repose by at least 0.25 degrees. In another example, the second angle of repose may be less than the first angle of repose by at least 0.5 degrees. In still another example, the second angle of repose may be less than the first angle of repose by at least 0.5 degrees and as much as 5 degrees.

### Example

The following example is provided to illustrate the invention. The example is not intended and should not be taken to limit, modify or define the scope of the present invention in any manner.

Samples of 20/40 mesh sand were coated with three different surfactants, each comprising EO/PO materials. The first surfactant (surfactant A) was an EO/PO based material marketed under the trade designation Ethox 1575 by Ethox Chemicals. The second surfactant (surfactant B) was an EO/PO based material marketed under the trade designation Ethox 4108 by Ethox Chemicals. The third surfactant (surfactant C) was an EO/PO based material marketed under the trade designation Ethox 4185 by Ethox Chemicals. Samples of the coated proppant were prepared by applying each surfactant in differing amounts to the uncoated proppant. A predetermined concentration of each surfactant was first dissolved in isopropyl alcohol and added to a 20/40 mesh sand sample in a beaker. The contents were stirred, and then the 20/40 mesh sand was allowed to dry thoroughly. This method ensured that the 20/40 mesh sand was uniformly coated with a certain concentration of surfactant based on a certain weight % of total coated proppant. The angle of repose was tested under ASTM method C: 1444-00, the Standard Method for Measuring the Angle of Repose of Free-Flowing Mold Powders. The results shown in the table (FIG. 9) demonstrate that for each sample there were concentrations of surfactant that resulted in a decrease in the angle of repose. Also, the results indicate that as the concentration of surfactant increased, the angle of repose for the coated proppant eventually increased to be greater than the angle of repose for the uncoated proppant.

According to the description above, various embodiments will now be described. According to one set of embodiments there is provided a coated proppant composition. The composition comprises a proppant having a first angle of repose and a chemical additive coated onto the proppant. The coated proppant has a second angle of repose. The second angle of repose is equal to or less than the first angle of repose. In some of these embodiments, the second angle of repose is less than the first angle of repose by at least 0.25 degrees, or 0.5 degrees. In other embodiments, the second angle of repose is less than the first angle of repose by from 0.5 degrees to 5 degrees.

In some of these embodiments, the coated proppant has a concentration of chemical additive equal to or less than 0.6 weight % based on the total coated proppant composition, equal to or less than 0.4 weight %, equal to or less than 0.2 weight %, or equal to or less than 0.15 weight percent.

In other embodiments, the coated proppant compositions above are produced by a method of applying a chemical additive to the proppant in a concentration such that the coated proppant has a second angle of repose, wherein the second angle of repose is no more than 10% greater than the first angle of repose. The application can include transferring the proppant into a pneumatic line such that the proppant flows through the pneumatic line. The chemical additive is applied to the proppant as the proppant flows through the pneumatic line to produce the coated proppant.

In some of these embodiments, the application of the chemical additive can occur by injecting the chemical additive into the pneumatic line such that a mist of atomized droplets of the chemical additive are applied to the proppant by countercurrent contact.

In other embodiments, the application of the chemical additive can occur by injecting the chemical additive into the pneumatic line such that a mist of atomized droplets of the chemical additive are applied to the proppant by introducing the mist in-line with the flow of proppant.

In still other embodiments, the application can occur in fluidized bed coater interspersed within the pneumatic line so that the fluidized bed coater applies the chemical additive to the proppant. The fluidized bed coater can comprise a housing defining a coating chamber for receiving proppant to be coated. The fluidized bed coater has an air inlet for delivering air into an underside of the coating chamber. The air inlet is operable for directing the airflow such that the proppant is circulated. As air circulates the proppant, opposing spray nozzles projecting upwardly from an underside of the coating chamber, spray the chemical additive into the coating chamber. The fluidized bed coater has a proppant inlet to receive proppant and a coated proppant outlet to release coated proppant. The fluidized bed coater can also have a system of internal partitions to aid in even chemical distribution and controlled proppant flow.

In the above embodiments, a high-pressure sprayer may be used to introduce the chemical additive into the pneumatic line or the fluidized bed. Also, the chemical additive can be introduced as a mist of atomized droplets having a mean particle size of about 100 microns or less in size. Often the mean particle size can be microns or less and can be 50 microns or less.

In some of these embodiments, the method applying the chemical additive to the proppant includes transferring the proppant from a first vessel to the pneumatic line. The chemical additive is applied to the proppant as the proppant flows through the pneumatic line. The coated proppant is then transferred to a second vessel to be used in oil well treatment operations.

In certain of these embodiments, the coated proppant is introduced into a well before well treatment operations using one or more pumps. The coated proppant can also be mixed with a fracturing fluid by a pump and blender system.

Therefore, the present invention is well adapted to attain the ends and advantages mentioned, as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified, and all such variations are considered within the scope and spirit of the present invention. While compositions and methods are described in terms of “comprising,” “containing,” “having,” or “including” various components or steps, the compositions and methods can also “consist essentially of” or “consist of” the various components and steps. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee.

What is claimed:

1. A method comprising:
transferring a proppant from a first vessel to a pneumatic line;
flowing the proppant through the pneumatic line;
applying to the proppant a chemical additive during flowing of the proppant through the pneumatic line to produce a coated proppant;
transferring the coated proppant to a second vessel; and
using the coated proppant for oil well treatment operations.

2. The method of claim 1, wherein the application occurs by injection of the chemical additive into the pneumatic line such that a mist of atomized droplets of the chemical additive are applied to the proppant by countercurrent contact, wherein the atomized droplets have a mean particle size of about 100 microns or less in size and the injection of the chemical additive to the proppant is by high pressure sprayer.

3. The method of claim 1, wherein the application occurs by injection of the chemical additive into the pneumatic line such that a mist of atomized droplets of the chemical additive are applied to the proppant by introducing the mist in-line with the flow of proppant, wherein the atomized droplets have a mean particle size of about 100 microns or less in size and the injection of the chemical additive to the proppant is by high pressure sprayer.

4. The method of claim 1, wherein a fluidized bed coater is interspersed within the pneumatic line so that application of the chemical additive to the proppant is by the fluidized bed coater, wherein the fluidized bed coater comprises a housing defining a coating chamber for receiving proppant to be coated; a flow line for delivering air into an underside of the coating chamber; opposing spray nozzles projecting upwardly toward the coating chamber from an underside thereof for spraying the chemical additive into the coating chamber; said flow line being operable for directing the air flow such that the proppant is circulated; and an proppant inlet for proppant and an coated proppant outlet for coated proppant.

5. The method of claim 1, wherein the proppant has a first angle of repose and the coated proppant has a second angle of repose and wherein the second angle of repose is no more than 10% greater than the first angle of repose and wherein the concentration of chemical additive is equal to or less than 0.6 weight % based on the total coated proppant additive.

6. The method of claim 1, wherein the coated proppant is introduced into a well bore for well treatment operations using one or more pumps.

7. The method of claim 6, wherein the coated proppant is mixed with a fracturing fluid by a pump and blender system prior to being introduced into the well bore.

8. The method of claim 1, wherein:
the application occurs by injection of the chemical additive into the pneumatic line such that a mist of atomized droplets of the chemical additive is applied to the proppant by countercurrent contact;
the atomized droplets have a mean particle size of about 50 microns or less;
the proppant has a first angle of repose and the coated proppant has a second angle of repose and wherein the second angle of repose is no more than 10% greater than the first angle of repose; and
the chemical additive is a surfactant and the concentration of the chemical additive is equal to or less than 0.5 weight % based on the total coated proppant additive.

9. The method of claim 1, wherein:
the application occurs by injection of the chemical additive into the pneumatic line such that a mist of atomized droplets of the chemical additive is applied to the proppant in-line with the flow of proppant;
the atomized droplets have a mean particle size of about 50 microns or less;
the proppant has a first angle of repose and the coated proppant has a second angle of repose and wherein the second angle of repose is no more than 10% greater than the first angle of repose; and
the chemical additive is a surfactant and the concentration of the chemical additive is equal to or less than 0.5 weight % based on the total coated proppant composition.

10. A method comprising:
providing a proppant having a first angle of repose;
applying to the proppant a concentration of chemical additive such that the coated proppant has a second angle of repose and wherein the second angle of repose is no more than 10% greater than the first angle of repose.

11. The method of claim 10, wherein the coated proppant has a concentration of chemical additive of equal to or less than 0.6 weight % based on the total coated proppant composition.

12. The method of claim 10, wherein the second angle of repose is no more than 5% greater than the first angle of repose.

13. The method of claim 10, wherein the second angle of repose is equal to or less than the first angle of repose.

14. A coated proppant composition comprising:
a proppant having a first angle of repose; and
a chemical additive coated on said proppant, wherein the coated proppant has a second angle of repose and wherein the second angle of repose is no more than 10% greater than the first angle of repose.

15. The composition of claim 14, wherein the coated proppant has a concentration of chemical additive of equal to or less than 0.6 weight % based on the total coated proppant composition.

16. The composition of claim 14, wherein the coated proppant has a concentration of chemical additive of equal to or less than 0.4 weight % based on the total coated proppant composition

17. The composition of claim 14, wherein the coated proppant has a concentration of chemical additive of equal to or less than 0.2 weight % based on the total coated proppant composition.

18. The composition of claim 14, wherein the second angle of repose is no more than 5% greater than the first angle of repose.

19. The composition of claim 14, wherein the second angle of repose is less than the first angle of repose by at least 0.25 degrees.

20. The composition of claim 14, wherein the second angle of repose is less than the first angle of repose by at least 0.5 degrees.
